(19) United States
(12) Patent Application Publication
(10) Pub. No.: US 2015/0349877 A1
(43) Pub. Date: Dec. 3, 2015

(54) SYSTEMS AND METHODS FOR WIRELESS DATA EXCHANGE WITHOUT NETWORK CONNECTIVITY

(71) Applicant: Seth Cirker, Port Washington, NY (US)

(72) Inventor: Seth Cirker, Port Washington, NY (US)

(21) Appl. No.: 14/292,567

(22) Filed: May 30, 2014

(51) Int. Cl. H04B 7/24

(52) U.S. Cl. CPC H04B 7/24

(57) ABSTRACT

In one example, a computer-implemented method to communicate information is disclosed. A device operates in accordance with a wireless client mode. A trigger event is detected. A beacon message that includes information is generated. The beacon message is generated in response to the trigger event. The generated beacon message is transmitted.

### BACKGROUND

The use of computer devices and computer-related technologies continues to increase at a rapid pace. This increased use of wireless computer devices has influenced the advances made to computer-related technologies. Indeed, computer devices have increasingly become an integral part of an individual's everyday activities as well as the business world. Computer devices may be used to carry out countless personal and business endeavors. The wide-spread use of these devices has been further accelerated by the increased use of Internet accessible wireless computer devices.

Wireless communication networks enable information to be spread quickly and efficiently. In order to exchange data (e.g., communicate) over a communication network, network connectivity is typically required. However, some communications networks intentionally limit network connectivity so that only certain devices may connect to the network. In many cases, it has become standard practice to limit access to wireless communication networks for security reasons. In these types of situations, those that are connected to a communication network may exchange data with the communication network, while those that are not connected to the communication network may not exchange data with the communication network. However, in some cases, it may be beneficial to exchange data without network connectivity.

### SUMMARY

In one example, a computer-implemented method to communicate information is disclosed. A device operates in accordance with a wireless client mode. A trigger event is detected. A beacon message that includes information is generated. The beacon message is generated in response to the trigger event. The generated beacon message is transmitted.

In some embodiments, the information may be based at least in part on the trigger event. For example, the information may be in response to the detected trigger event.

In some embodiments, the device may operate in accordance with an access point mode. In some cases, the generating the beacon message and the transmitting the beacon message may be performed while operating in accordance with the access point mode.

In some embodiments, the device may switch from operating in accordance with the client mode to operating in accordance with the access point mode. In some cases, at least a portion of the operating in accordance with the client mode is suspended during the operating in accordance with the access point mode. In some embodiments, the device may switch from operating in accordance with the client mode to operating in accordance with a hybrid mode. In some cases, operating in accordance with the hybrid mode may include transmitting the beacon message while continuing to operate in accordance with the client mode.

Upon transmitting the beacon message, the device may switch from operating in accordance with the access point mode or the hybrid mode to operating in accordance with the client mode. In some embodiments, a second beacon message may be received from a disparate device. In one example, the second beacon message may be generated by the disparate device based at least in part on the transmitted beacon message. In one example, the beacon message may be transmitted by the device and the second beacon message may be received from the disparate device without network connectivity between the device and the disparate device.

In some embodiments, operating in accordance with the client mode may include maintaining network connectivity with an access point. In one example, operating in accordance with the client mode may include listening for beacon messages. In some embodiments, the device lacks network connectivity with an access point. In one example, at least a portion of the information is included in a service set identifier (SSID) field of the beacon message.

A device configured to communicate information is also described. The device includes a processor and memory in electronic communication with the processor. The memory stores instructions, the instructions being executable by the processor to operate in accordance with a client mode, detect a trigger event, generate a beacon message that includes information, wherein the information is based at least in part on the trigger event; and transmit the generated beacon message.

A computer-program product to communicate information is additionally described. The computer-program product includes a non-transitory computer-readable medium having instructions thereon, the instructions being executable by a processor to operate in accordance with a client mode, detect a trigger event, generate a beacon message that includes information, wherein the information is based at least in part on the trigger event, and transmit the generated beacon message.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is a block diagram illustrating one example of an environment in which the present systems and methods may be implemented;

FIG. 2 is a block diagram illustrating one example of a data exchange module;

FIG. 3 is block diagram illustrating one example of a beacon message;

FIG. 4 is a block diagram illustrating one example of a data exchange module and the environment in which it may be implemented;

FIG. 5 is a block diagram illustrating another example of a data exchange module and the environment in which it may be implemented;

FIG. 6 is a block diagram illustrating an example notification message that may be displayed to a user;

FIG. 7 is a block diagram illustrating another example of a data exchange module and the environment in which it may be implemented;

FIG. 8 is a block diagram illustrating another example of a data exchange module and the environment in which it may be implemented;

FIG. 9 is a block diagram illustrating another example of a data exchange module and the environment in which it may be implemented;

FIG. 10 is a flow diagram illustrating one embodiment of a method for communicating data;

FIG. 11 is a flow diagram illustrating another embodiment of a method for communicating data; and

FIG. 12 depicts a block diagram of a computer system suitable for implementing the present systems and methods.

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION OF EXEMPLARY EMBODIMENTS

In one example, the systems and methods described herein may enable a wireless device to alert and/or exchange data with a nearby wireless device without being connected to the nearby wireless device. In another example, the systems and methods described herein may enable a wireless device to be alerted by and/or exchange data with a nearby wireless device without being connected to the nearby wireless device.

More and more everyday devices are gaining wireless capabilities. For example, smoke detectors, carbon monoxide detectors, doorbells and thermostats, may include wireless capabilities. In some cases, these wireless connected devices may connect to a wireless network to provide alerts and/or exchange data with devices that are connected to the network. However, in many cases, connectivity with wireless networks is restricted so that only those with the appropriate credentials can connect to the network. Therefore, not all nearby devices may be connected to the network. As a result, nearby devices may not receive alerts and/or may not exchange data with the nearby wireless device.

Accordingly, it may be desirable for a user's portable electronic device (e.g., cell phone, smart phone, tablet, laptop, wearable electronic device, etc.), which is not connected to a network, to be alerted by and/or exchange data with a nearby wireless device. Additionally or alternatively, it may be desirable for a wireless device to alert and/or exchange data with a nearby wireless device when the wireless device is operating in a standalone manner.

For example, in the event of a dangerous condition, it would be desirable for a wireless smoke detector to alert not only the limited number of devices connected to its wireless network, but every device (e.g., smart phone, tablet, personal device) in its proximity. As described below, the described systems and methods may enable a wireless device (e.g., wireless smoke detector) to alert and/or exchange data with every device (e.g., personal electronic devices) that are in its proximity, and enable every device in that proximity to be alerted and/or to exchange data with the wireless device. In some cases, the described systems and methods may enable this alerting and/or exchanging of data while maintaining the highest wireless network security and performance standards. As described herein, the alerting and/or exchanging of data may occur without requiring network connectivity (or network access, for example). Thus, eliminating many network concerns.

In one example, when a networked wireless device (e.g., a smoke detector) is triggered to alert a nearby wireless device (e.g., a personal electronic device), the wireless device may temporarily switch from operating in accordance with a client mode to operating in accordance with an access point mode. After changing modes, the wireless device may generate and transmit a beacon message containing data relevant to the event that triggered the beacon message. Upon sending the beacon message, the wireless device may return to operating in accordance with the client mode. In some cases, the wireless device may maintain the connection with its wireless network. In other cases, the wireless device may re-associate with the wireless network upon returning to operating in accordance with the client mode.

Continuing with this example, every nearby device within range of the wireless device may receive the beacon message. Based upon instructions contained in the operating system (OS) or in a mobile application (e.g., an app) running on the nearby wireless device, the nearby wireless device may react accordingly. For example, the nearby wireless device may alert a user by displaying event related information, sounding a tone, and/or vibrating.

In some cases, the nearby wireless device may additionally respond to the wireless device by similarly switching from operating in accordance with a client mode to operating in accordance with an access point mode, generating its own beacon message, and transmitting its own beacon message. In one example, since the wireless device would have already returned to operating in accordance with the client mode and re-associated with its network, the wireless device may listen (according to Wi-Fi standards, IEEE 802.11, for example) for beacon message from other access points and may receive the beacon message from the nearby wireless device. In one example, based upon instructions contained in the wireless device's firmware, the wireless device may react accordingly, such as by acknowledging an alarm or by making the information provided by the nearby wireless device available to others.

In some cases, a wireless mode change and beacon message transmission may occur on a wireless device which might be operating in a standalone manner, such as a smoke detector. In this situation, self-aware state changes like the detection of smoke, heat or carbon monoxide as well as fault conditions such as low batteries, loss of alternating current (AC) power or network connectivity may be used to trigger the wireless mode change and beacon message transmission. Other monitored conditions including temperature, humidity, occupancy, motion and time may also be used to activate the wireless device's mode change and beacon message transmission.

In some embodiments, a wireless mode change and beacon message transmission may also occur on portable devices like smartphones and tablets. Similar changes in the portable device's self-aware conditions including location or movement may trigger the wireless mode change and beacon message transmission.

In addition to self-aware conditions, the wireless mode change and beacon message transmission may be triggered by information provided by the device's OS, firmware, or software running on it. A wireless mode change and beacon message transmission may also be triggered by an external event such as the reception of a beacon message from another wireless device or information provided by an entirely separate device or application.

With the ability for each device to send and receive beacon messages, a two-way capability exists whereby wireless “client” devices can “poll” portable devices in their proximity for information. In the case of the smoke detector, authorities and responders may be provided with the number of smartphones at an incident, as well as other potential information, such as phone numbers and device owners' names. Likewise, upon detecting motion, a Wi-Fi doorbell may automatically identify who's at the door just as a Wi-Fi thermostat may adjust the room temperature to an individual's liking, all without requiring network connectivity or access.

With an internet connection, which often exists, the value of beacon messages is greatly increased as the data exchanged is not the limited to static data contained in each device, such as the room or person's name, but can now include dynamic data obtained in real-time from remote servers. For example, the beacon message may include a uniform resource locator (URL) that references dynamic data accessible via remote servers.

In one example, in addition to sending a beacon message when a dangerous condition exists, a smoke detector may send a location identifying beacon message when motion is detected or at predetermined times. Using the beacon messages as a precise location reference and other available information such as the date and time, weather and items like an individual's personal preferences and habits, highly effective contextual messages may be generated. In one example, visual messages may be seen on an individual's smartphone, using its 3G, 4G or LTE connection or on a nearby internet connected TV, game console or digital signage system, while audible messages may be delivered over internet-connected music systems.

In one example, the systems and methods described herein may allow for deaf or hearing impaired individuals to be alerted of emergency events. In one example, by placing a user's portable device in a vibration sensing cradle, a “bed shaker” may be activated to alert deaf or hearing impaired individuals while they are asleep.

In another example, a person at the door may be identified without network connectivity. For example, upon approaching a home's front door, either the individual's proximity being detected or a push of the doorbell button may trigger the doorbell to change modes and transmit a beacon message polling the individual's smartphone, asking “Who's there?” The individual's smartphone may then automatically respond and pass the device owner's name on to the doorbell system. Homeowners would know if a known or unknown person was at the door. In some cases, a delivery person's authenticated wireless device may similarly identify them.

In another example, a Wi-Fi thermostat may alert individuals if their heat fails in another part of the house or while they are asleep. Also, upon detecting motion the thermostat may poll the portable device to determine who's in the room and set the temperature to their likings. A similar benefit exists in other areas like rental properties and hotel rooms, where the heating, ventilation, and air-conditioning (HVAC) systems may be automatically set to the guest's preferences.

In yet another example, a Wi-Fi Motion Detector (standalone or incorporated in another device) may poll information about a user in proximity of the motion detector. For example, upon detecting someone in its proximity, mobile devices may be polled for the device owner's information. The individual's name, sex, and age may be obtained either directly from their mobile device or by referencing information related to the mobile device online.

Additionally or alternatively, smart televisions may automatically display content and adjust features such as enabling Skype profiles based upon who is in the room. Similarly, internet music systems may automatically play music based upon who is in the room. In addition, Wi-Fi appliances may alert nearby individuals when a task is complete or when a problem exists.

In one example, the systems and methods described herein may be used to create a personal safety device. For example, an individual's smartphone may respond to beacon messages sent by search and rescue teams or first responders with critical information such as the owner's name, location, medical conditions, allergies. A smart phone may also alert the owner that responders are in the area.

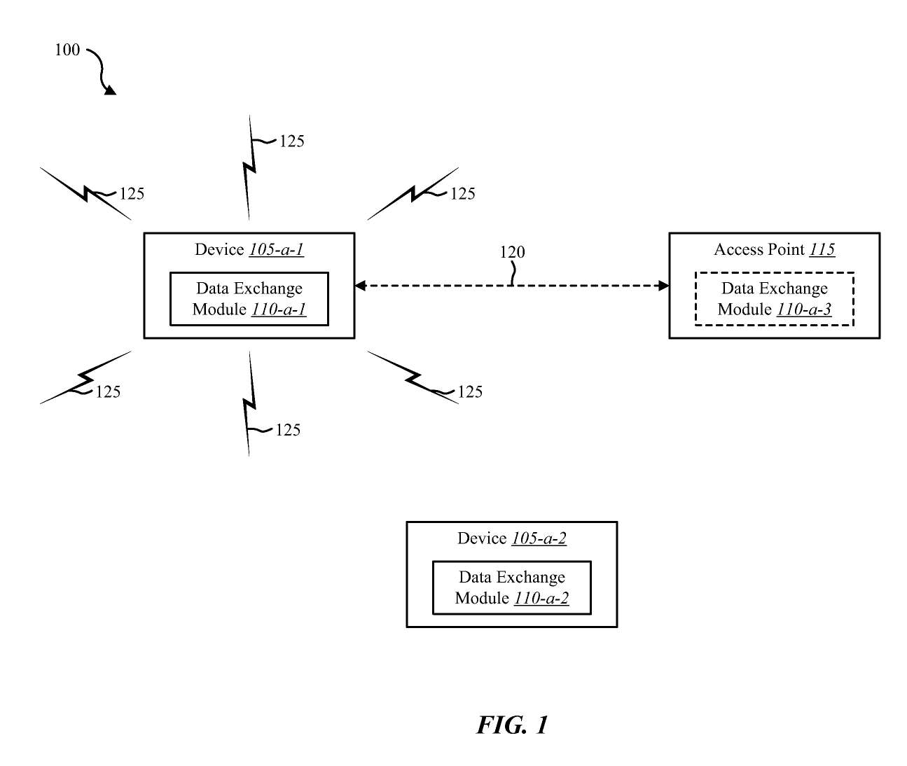

Referring now to the figures, FIG. 1 is a block diagram illustrating one example of an environment 100 in which the present systems and methods may be implemented. The environment 100 may include a plurality of devices 105 and may optionally include an access point 115. Examples of devices 105 include wireless capable devices (e.g., smoke detectors, carbon monoxide detectors, doorbells, security systems, thermostats, computers, appliances, vehicles, etc.) and portable electronic devices (e.g., smart phones, tablet, wearable devices, laptops, etc.). The access point 115 may allow wireless devices to connect to a communication network. In one example, the devices 105 and the access point 115 may be compliant with the Institute of Electrical and Electronics Engineers (IEEE) 802.11 and/or other similar standards.

In one example, the first device 105-a-1 may be connected 120 to a communication network (via access point 115, for example) while the second device 105-a-2 may not be connected to the communication network. For example, the second device 105-a-2 may be unable to connect to the communication network due to security restrictions enforced by the access point 115.

Present wireless capable devices, such as wireless capable smoke detectors, may provide alerts and/or data through conventional network communication. Accordingly, only devices that are connected to (e.g., have network connectivity with) the communication network may receive the alerts and/or data. As a result, devices that are not connected to the communication network, such as the second device 105-a-2 in this example, may not receive these alerts and/or data. However, it may be desirable for all devices to receive the alerts and/or data. Unfortunately, these types of situations may be prevalent due to the widely adopted practices of restricting access to wireless communication networks. As described herein, the present systems and methods may enable alerts and/or data exchange with nearby wireless devices without network connectivity.

In some cases, the devices 105 may operate in accordance with a client mode. For example, the first device 105-a-1 may connect and/or communicate with the access point 115 as a client device. In another example, the second device 105-a-2 may scan for wireless networks that the second device 105-a-2 may connect to as a client. Whether the device 105 is connected to a communication network or not, operating in accordance with a client mode may include listening for beacon messages. For example, a device 105 that is operating in accordance with the client mode may listen for beacon messages from access points to identify access points that the device 105 may connect to and/or handover to.

In one example, the devices 105 may include a data exchange module 110. In one embodiment, the data exchange module 110 may enable a device 105 to alert and/or exchange data with a nearby device (e.g. device 105) and/or may enable a device 105 to be alerted by and/or exchange data with a nearby device (e.g., device 105). In one example, the data exchange module 110 may monitor for the trigger event and upon detection of a trigger event, may switch operating modes. For example, the device 105 may operate in accordance with an access point mode. In one example, the exchange module 110 may suspend one or more functions associated with operating in accordance with client mode in order to switch to operating in accordance with an access point mode. For instance, the data exchange module 100 may suspend or terminate the connection 120 with the communication network to switch to operating in accordance with the access point mode. In another example, the exchange module 110 may switch to operating in accordance with a hybrid mode that enables the device 105 to continue operating in accordance with the client mode while also operating in accordance with the access point mode. In some cases, operating in accordance with the access point mode includes generating a beacon message 125 and transmitting the beacon message 125.

In one example, the first data exchange module 110-a-1 may generate a beacon message 125 in response to the detected trigger event. The generated beacon message may include information. In one example, at least a portion of the information may be based at least in part on the detected trigger event. For example, in the case of the smoke detector, the generated beacon message 125 may include information about the type of alarm and/or instructions for responding to the alarm (e.g., what to do, where to exit, etc.). In another example, at least a portion of the information may be in response to the detected trigger event but may be unrelated to the detected trigger event. For example, the information may include a uniform resource locator (URL) that points to an accessible database (e.g., dynamic database) that contains additional information. In one example, referencing information in an accessible database may enable substantially more information to be provided than can be included in the limited resources of the beacon message 125. The first exchange module 110-a-1 may transmit the generated beacon message 125 and may switch back to operating in accordance with the client mode. In some cases, multiple (repeated, for example) beacon messages 125 may be transmitted. Additionally or alternatively, multiple beacon messages 125 may be used to carry the information (if the information cannot fit within a single beacon message 125, for example). In one example, switching back to operating in accordance with the client mode includes re-assuming the connection 120 with the access point 115.

In one example, the second device 105-a-2, which may be operating in accordance with the client mode (and thus listening for beacon messages from access points, for example), may receive the beacon message 125 and may react accordingly. In one example, the second data exchange module 110-a-2 in the second device 105-a-2 may provide a notification to a user based on the information received in the beacon message 125. In another example, the second data exchange module 110-a-2 may detect the received beacon message 125 as a trigger event and may similarly switch operating modes and respond with a second beacon message that includes information (based at least in part on the received beacon message, for example). In this way, the data exchange module 110 may provide alerts and/or exchange data without network connectivity. Additionally, alerts and/or data may be exchanged without impacting or interrupting network security or connectivity restrictions.

In some cases, the access point 115 may similarly include a third data exchange module 110-a-3. In one example, the third data exchange module 110-a-3 upon detecting a trigger event may switch from operating in accordance with an access point mode (which would be the typical operating mode for the access point 115, for example) and may temporarily operate in accordance with a client mode. For example, the third data exchange module 110-a-3 may temporarily switch the operating mode of the access point 115 from operating in accordance with the access point mode to operating in accordance with the client mode so that the access point 115 may listen to and receive beacon messages.

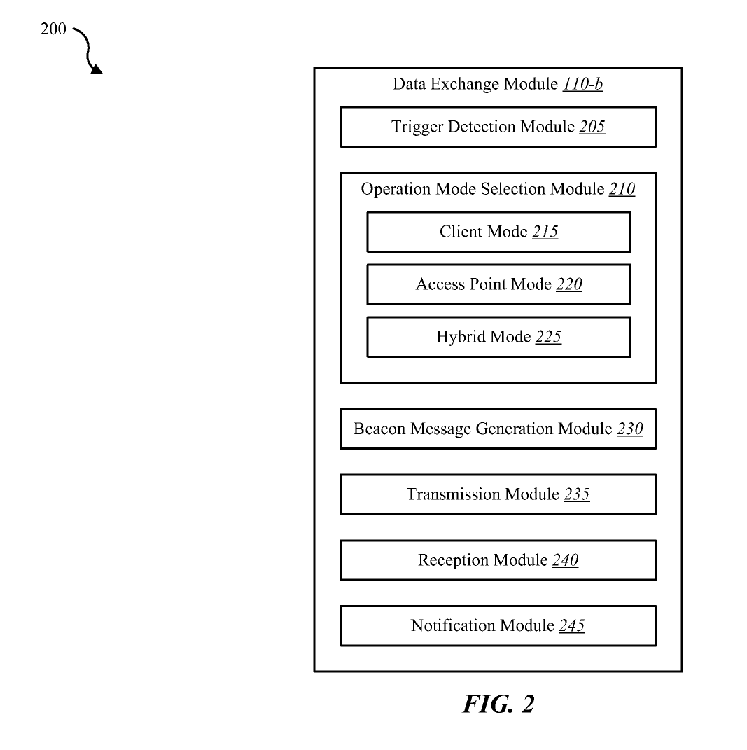

FIG. 2 is a block diagram 200 illustrating one example of a data exchange module 110-b. The data exchange module 110-b may be one example of the data exchange modules 110 illustrated in FIG. 1. In one example, the data exchange module 110-b may include a trigger detection module 205, an operation mode selection module 210, a beacon message generation module 230, a transmission module 235, a reception module 240, and a notification module 245.

In some embodiments, the trigger detection module 205 may monitor for a trigger event. In one example, the trigger event may be based on the change in a self-aware state (e.g. smoke and/or carbon monoxide CO, temperature, humidity, motion, etc.). For instance, the trigger event may be the detection of smoke by a smoke detector. In another example, the trigger event may be based on an external event such as the reception of a beacon message (a data exchange beacon message, for example). It is understood, that any detectable event (e.g., change in an input, reception of a message, etc.) may be a trigger event. In some cases, the trigger detection module 205 may monitor for trigger events and may detect a trigger event upon the occurrence of the trigger event. In some cases, the data exchange module 110-b may respond differently based on the type of trigger event that the trigger detection module 205 detects.

In some embodiments, the operation mode selection module 210 may select the operating mode (e.g., client mode 215, access point mode 220, or hybrid mode 225) of the device 105 (or access point 115, for example). For example, the operation mode selection module 210 may select the mode that the device 105 should be operating in. Additionally or alternatively, the operation mode selection module 210 may enable the device 105 to change from operating in accordance with a first mode to operating in accordance with a second mode. For example, the operation mode selection module 210 may enable the device 105 to change from operating in accordance with the client mode to 215 to operating in accordance with the access point mode 220 or operating in accordance with the hybrid mode 225.

In some embodiments, operating in accordance with the client mode 215 may include listening for and receiving beacon messages. Beacon messages are typically transmitted by access points (e.g., access point 115) to indicate the presence of a wireless network. Accordingly, client devices (e.g., device 105) may continually listen for beacon messages so that the client device may become aware of nearby wireless networks and may (if desired) switch to a more nearby access point. As described herein, this continual listening for and receiving of beacon messages may allow for data exchange without network connectivity. For example, a device 105 that is operating in accordance with the client mode 215 may listen for and receive a beacon message that contains information.

In one example, operating in accordance with the access point mode 220 may include generating and transmitting (e.g., broadcasting) beacon messages. Access points (e.g., access point 115) typically transmit beacon messages to indicate the presence of the wireless network that the access point is hosting. As described herein, the generation and transmission of beacon messages may allow for data exchange without network connectivity. For example, a device 105 that is operating in accordance with the access point mode 220 may generate and transmit a beacon message that contains information.

In one example, operating in accordance with the hybrid mode 225 may include all of the functionality associated with operating in accordance with the client mode 215 and all of the functionality associated with operating in accordance with the access point mode 220. For example, operating in accordance with the hybrid mode 225 may include listening and receiving beacon messages, and generating and transmitting beacon messages. In some cases, operating in accordance with the hybrid mode 225 eliminates the need for switching between operating in accordance with the client mode 215 and operating in accordance with the access point mode 220.

In some cases, the operation mode selection module 210 may temporarily switch between operating in accordance with the native operation mode (e.g., client mode 215 for a client device, access point mode 220 for an access point) and operating in accordance with a temporary operation mode based on a trigger event (as detected by the trigger detection module 205, for example). In one example, the operating mode selection module 210 may switch from operating in accordance with a client mode 215 to operating in accordance with an access point mode 220 so that data carrying beacon message may be generated and sent. Following the transmission of the data carrying beacon message the operating mode selection module 210 may switch back to operating in accordance with the client mode 215 (the native operating mode, for example).

In some embodiments, the beacon message generation module 230 may generate a beacon message that carries data (e.g., information). In one example, the generated beacon message (e.g., beacon message 125) may carry information by replacing at least a portion of one or more fields of a beacon frame with the information (in place of the information that is typically included in that field, for example). For example, the beacon generation module 230 may use the SSID field to transmit the information. Additionally or alternatively, other fields may be used to carry information. The information may be based at least in part on the detected trigger event. In some cases, information that is based at least in part on to the detected trigger event includes information that is in response to the detected trigger event (but otherwise unrelated to the detected trigger event, for example). Since, the generated beacon message is being used to convey information rather than indicate the presence of a wireless network, one or more fields that are typically used to convey information about a wireless network may be repurposed to carry other information. In some cases, the beacon generation module 230 may generate a beacon message that includes a reference (e.g., Uniform Resource Locator) that references (all or at least a portion) of the information that the data exchange module 110-b is trying to convey.

In some embodiments the transmission module 235 may transmit (e.g., broadcast) the generated beacon message. For example, the transmission module 235 may transmit the generated beacon message at a selected power level. In some cases, the selected power level may be chosen to reduce the area in which the transmitted beacon message may be received (enabling location specific beacon messages, for example). In one example, the transmission module 235 may transmit generated beacon message according to the appropriate timing specifications for beacon message transmission. In another example, the transmission module 235 may transmit the generated beacon messages without regard to typical timing constraints for beacon message transmission (is not confined to transmitting the beacon message according to a particular schedule and/or not confined to waiting a specific amount of time before transmitting a subsequent generated beacon message). In one example, multiple beacon messages may be used to carry information. For example, the transmission module 235 may generate a first beacon message and a second beacon message and may transmit both the first and second beacon messages without delay (may transmit as soon as each message is generated, for example). In some cases, this may allow for more information to be transmitted than can be included within the constraints of a single beacon message.

In some embodiments, the reception module 240 may receive a beacon message. For example, the reception module 240 may receive a beacon message that was generated to include additional information. In some embodiments, the reception module 240 may provide control information and/or control signals to the device (e.g., device 105) based on the additional information included in a received beacon message. For example, the reception module 240 may control a device (e.g., device 105) based on the information included in a received beacon message. For instance (in the case that a smoke detector sends a beacon message that includes information about the detection of smoke), the reception module 240 may control the smoke detector to silence (at least temporarily, for example) an audible alarm sounding at the smoke detector based on the information included in a beacon message received from a disparate device. Similarly, the reception module 240 may control a thermostat to adjust a temperature setting based on information included in a beacon message. In one example, the reception module 240 may control a device via direct interaction with a controller for the device and/or via an application programming interface (API) provided by the device.

In some embodiments, the notification module 245 may provide notification to a user of the device (e.g., device 105) based on the additional information included in the received beacon message. For example, the notification module 245 may display a notification on the screen, may implement a sound, and/or may vibrate, to notify and/or get the attention of the user. In one example, a user may be alerted to a displayed notification message that includes information for the user. In one example, the notification module 245 may seek acknowledgment from the user that the notification message was received. In some cases, the notification module 245 may display a URL (or a link that hyperlinks to the URL) as part of the notification. In one example, the URL may reference additional information about the content of notification and/or about or related to the triggered event.

In some embodiments, the data exchange module 110-b may use a beacon message to initiate standard wireless communications with a disparate device. In one example, a wireless client device (e.g., smoke detector) may be operating in a standalone mode (no network connection, for example). Upon detecting motion, the wireless client device may transmit a scheduled beacon message polling portable wireless devices for the version of the latest smoke detector firmware. In one example, a portable device may be alerted that new firmware is required for the smoke detector and may be directed what to do.

In one example, if/when the latest firmware may be provided by the portable wireless device, the portable wireless device may send a beacon message telling the smoke detector to switch to access point mode (using a specific SSID and password, for example). The portable wireless device could then connect to the smoke detector (using standard wireless communications, for example) and exchange the file. Upon completion of the communications, the smoke detector may return to operating in accordance with the client mode and returns to standalone operation (or reconnects to its network if it was originally connected to a network, for example). Alternatively, if the portable device supports a “hotspot mode”, it could switch to access point mode and the smoke detector could connect to it to receive the updated firmware via the device's Internet connection (e.g., 3G, 4G, or LTE connection).

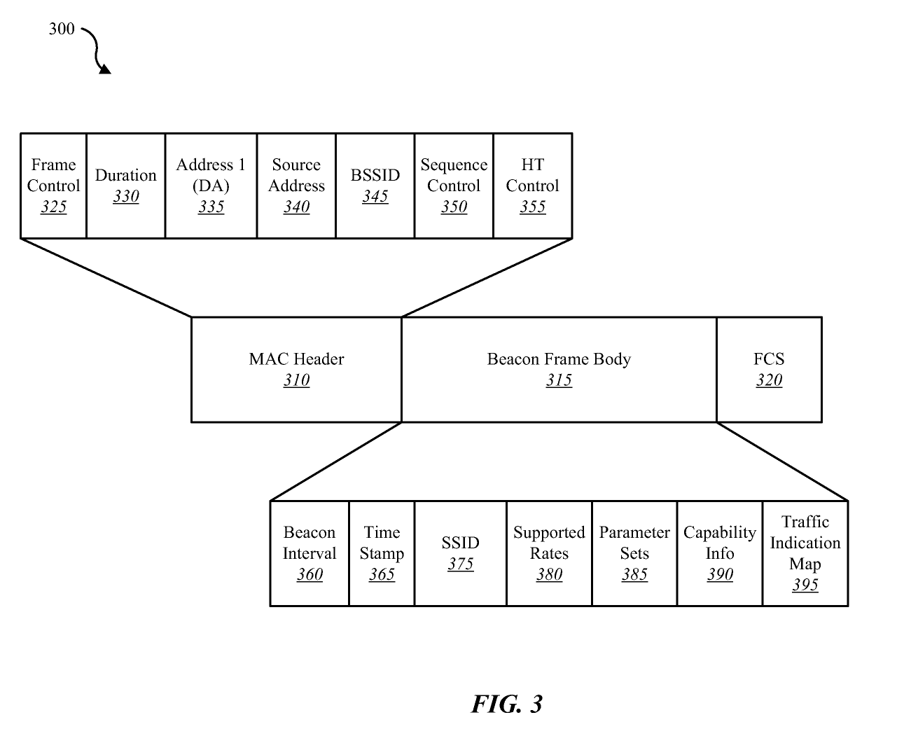

FIG. 3 is block diagram illustrating one example of a beacon message 300. The beacon message 300 may be one example of the beacon message 125 illustrated in FIG. 1. The beacon message 300 may include a media access control (MAC) header 310, a beacon frame body 315, and a frame check sequence (FCS) 320.

In one embodiment, the MAC header 310 may include a frame control field 325, a duration field 330, a destination address field 335, a source address field 340, a basic service set identification (BSSID) 345 a sequence control field 350, and/or a high throughput (HT) control field 355. In one embodiment, the beacon frame body 315 may include a beacon interval field 360, a timestamp field 365, a service set identifier (SSID) field 375, a supported rates field 380, a parameter sets field 385, a capability information field 390, and/or a traffic indication map field 395.

In some embodiments, a generated beacon message may replace a portion of or all of one or more fields with information (information about a triggered event or related thereto, for example). For example, the data exchange module 110 may use the SSID field 375 to carry the information. Since a generated beacon message is being used to carry information rather than to indicate the presence of a wireless network, the SSID field 375 and/or other fields that our typically purposed for indicating information about a wireless network may be repurposed to carry the information. In one example that information may include information related to a triggered event and/or may include a URL that references information related to the triggered event. In some embodiments, the information may include information for controlling and/or interacting with a disparate device. In one example, information for controlling and/or interacting with a disparate device may be included in response to a beacon message (e.g., a polling beacon message) received from the disparate device.

In one example, the information included in beacon message may be marked (e.g., identified and/or secured for limited access). For example, a unique code may be included in the beacon message (in at least a portion of the SSID field 375, for example). In one example, the unique code may indicate that the information is being sent by a particular manufacturer or provider. In some cases, a device (e.g., device 105) might be enabled to accept and/or reject beacon messages from particular manufacturers and/or providers.

In some cases, the format of the beacon message 300 may vary depending upon the application. For example, there may be a variety of options for adding data to a beacon message. In one example, data may be encapsulated in different segments of the beacon message such as the SSID, Information Element, or BSSID fields. In some embodiments, the beacon message may still be transmitted consistent with the IEEE 802.11 standard's requirements.

Similarly, the content of beacon messages may differ as applications may require different data to be exchanged. For example, beacon messages from a smoke detector might include information detailing the triggering event such as “Smoke Detected in Kitchen” while beacon messages from a motion detector might include a hyperlink to a location specific webpage or request specific information from portable devices. Accordingly, beacon messages from an individual's smartphone might include the phone owner's name, room temperature, or entertainment preferences.

Regardless of the beacon message format used to send data, since beacon messages are typically transmitted unencrypted “in the clear”, in some cases it may be beneficial to confirm the validity of such messages thereby minimizing the potential for “spoofed” messages. In one example, an “identifier” in the beacon message may be validated by the receiving device using two step verification, public key cryptography or some other authentication process. This may ensure that the beacon message was sent by a trusted source. This same or a similar “identifier” may be used as a means to filter beacon messages. With it, individuals may configure their smartphones to only acknowledge or respond to particular beacon messages, such as emergency alerts. Although beacon messages are typically transmitted unencrypted, in some cases, at least a portion of the information included in the beacon message may be encrypted. For example, sensitive data may be protected through encryption or by transmitting a pseudo-random or unique identifier instead which needs to be cross-referenced in a secure database to reveal such sensitive information.

In some cases, the beacon message 300 may be sent at significantly lower power levels than traditional Wi-Fi network communications would allow. By operating at such low levels, the area in which these beacon messages can be received may be greatly reduced. In one example, a wireless client device may select a reduced power level to select the area in which the beacon message 300 may be received. As a result, the wireless and may transmit the beacon message 300 to a selected (e.g., reduced) area by transmitting the beacon message 300 at the selected power level. This may greatly improve location granularity and the accuracy of location specific beacon messages that are sent to devices. In some cases, this may enable beacon messages 300 to be used as homing beacons. In one example, a wireless client device (such as a smoke detector or thermostat) may transmit a homing beacon (a beacon message 300 sent at a reduced power level, for example) to an area that substantially corresponds with the area of a room upon detecting motion in the room.

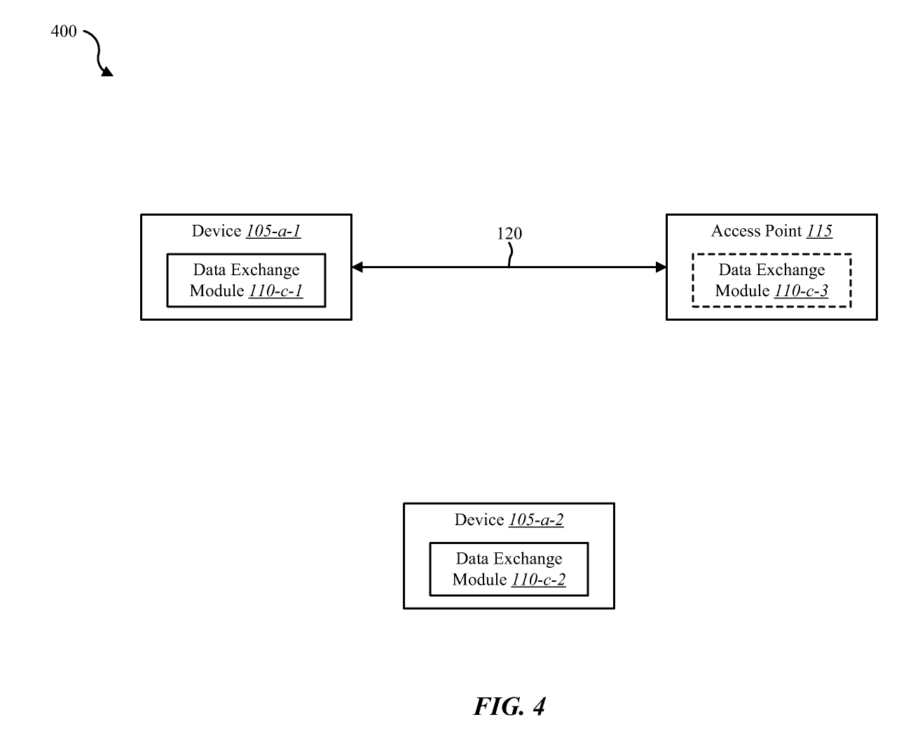

FIGS. 4-9 provide various embodiments of the present systems and methods. FIG. 4 is a block diagram illustrating one example of a data exchange module 110 and the environment 400 in which it may be implemented. As described with respect to FIG. 1, a first device 105-a-1 may be connected to a communication network via access point 115 and connection 120. In one example, the access point 115 may provide Internet connectivity to the first device 105-a-1 via connection 120. A second device 105-a-2 may not be connected to the communication network. The second device 105-a-2 may not be connected to the communication network. In some cases, the second device 105-a-2 may not be connected to any communication network. In other cases, the second device 105-a-2 may be connected to a disparate communication network (not shown). Each of the devices 105 and the access point 115 may be within range of each other.

In one example, the device 105-a-1, which in this case may be a smoke detector, may receive event data from other external sources. For example, the smoke detector may receive information, via the network, that an active shooter is in the building. In one example, the first data exchange module 110-c-1 may be alerted to the active shooter alarm from access point 115 via connection 120. In some cases, the second device 105-a-2, which is not connected to the communication network, unfortunately may not be alerted of the active shooter alarm because it is not connected to the communication network. This lack of information at the second device 105-a-2 may result in lack of preparation, misinformation, and/or chaos. Fortunately, the systems and methods described herein may enable the second device 105-a-2 to be alerted and informed without network connectivity.

In one example, the first data exchange module 110-c-1, upon detecting the active shooter alarm (a trigger event, for example), may switch from operating in accordance with a client mode to operating in accordance with an access point mode or hybrid mode. In some cases, the first data exchange module 110-c-1 may maintain the connection 120 with the access point 115 despite the switching and operating in accordance with the access point mode or hybrid mode. In other cases, the first data exchange module 110-c-1 may temporarily suspend or terminate the connection 120 with the access point 115 when operating in accordance with the access point mode and/or hybrid mode. The data exchange module 110-c-1, now operating in accordance with an access point mode or hybrid mode may generate a beacon message that includes information related to the active shooter event.

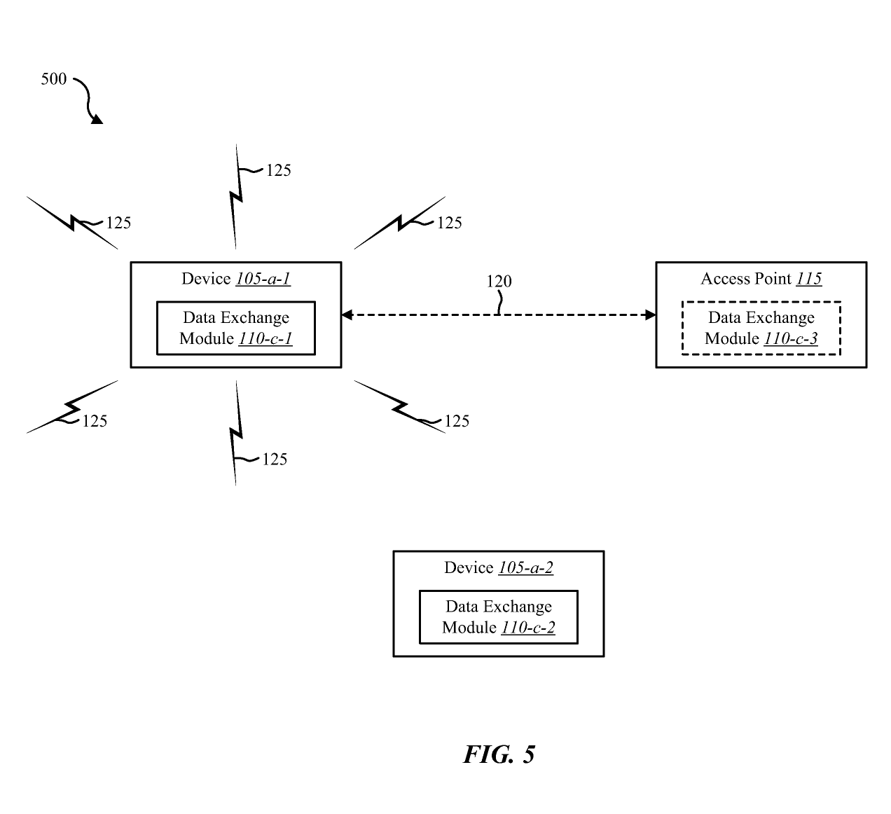

Referring now to FIG. 5, FIG. 5 is a block diagram illustrating another example of a data exchange module 110 and the environment 500 in which it may be implemented. As illustrated in FIG. 5, the first data exchange module 110-c-1 may transmit the generated beacon message 125. In one example, the first data exchange module 110-c-1, upon transmitting the generated beacon message 125 may switch (return, for example) from operating in accordance with the access point mode or hybrid mode to operating in accordance with the client mode. The second device 105-a-2 may be a client device that is operating in accordance with the client mode. In one example, the second data exchange module 110-c-2 may receive the generated beacon message 125 (in accordance with IEEE 802.11 standards, for example). The second data exchange module 110-c-2, upon receiving the generated beacon message 125 may provide a notification to the user based on the information included in the generated beacon message 125.

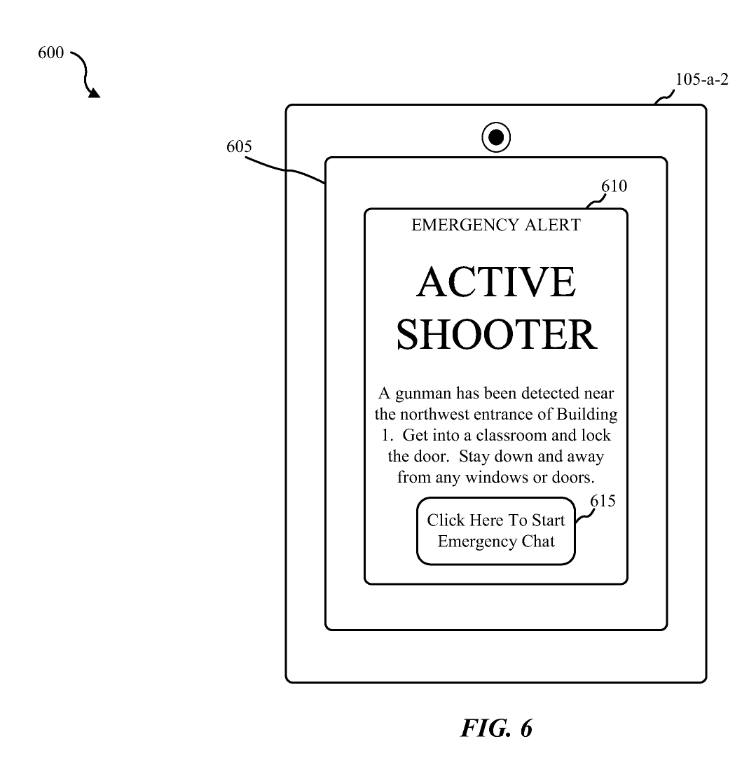

FIG. 6 is a block diagram 600 illustrating an example notification message 610 that may be displayed to a user. In some embodiments, the second device 105-a-2 may include a display 605. The data exchange module 110-c-2 may display a notification message 610 on the display 605. In one example, the notification message 610 may indicate that there is an emergency alert and that the emergency alert is for an active shooter situation. In some cases, the notification message 610 may additionally provide information about event (e.g., the location where the active shooter's was first reported). Additionally or alternatively, the notification message 610 may include instructions for reacting to the specific event (active shooter-emergency alert). In one example, the notification message 610 may include a URL that references additional details and/or real-time updates.

In some cases the notification message 610 may include a user interactive button 615 in which the user can initiate two-way communication. For instance, the user interactive button 615 may start an emergency chat. In one example, starting an emergency chat may include using beacon messages to support two-way communication. For instance, the user may communicate information (with an emergency responder, for example) by transmitting information in a beacon message and may receive information by listening for and receiving beacon messages containing information. As a result, two-way communication may be supported without network connectivity.

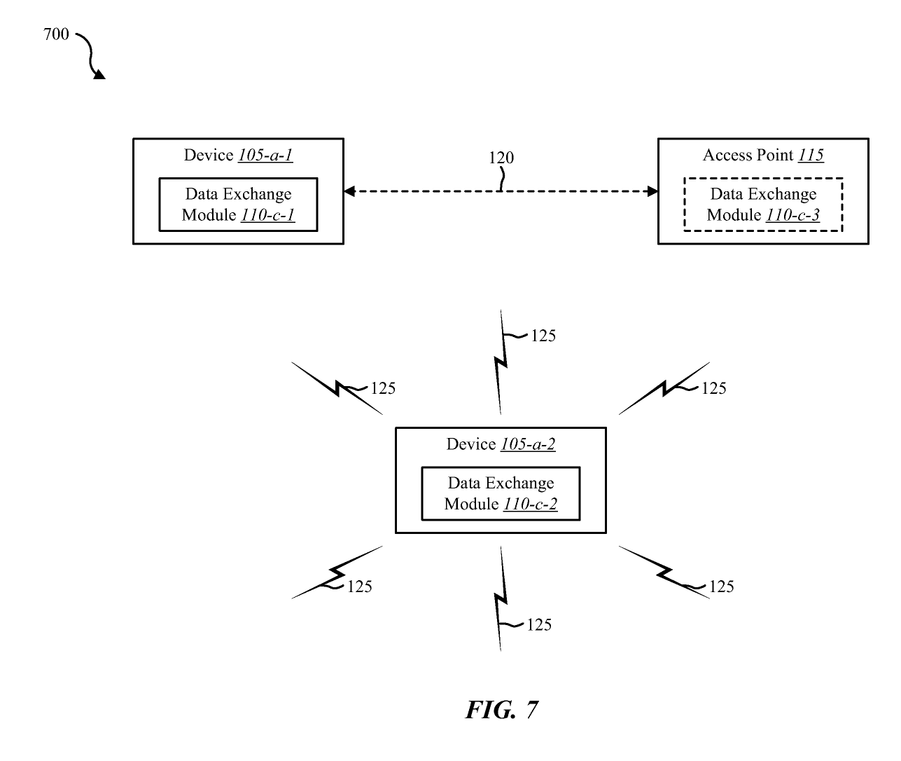

Referring now to FIG. 7, FIG. 7 is a block diagram illustrating another example of a data exchange module 110 and the environment 700 in which it may be implemented. In some embodiments, the second exchange module 110-c-2 may recognize the received beacon message as a triggering event. In one example, upon receiving the beacon message, the second data exchange module 110-c-2 may switch the second device 105-a-2 from operating in accordance with the client mode to operating in accordance with the access point mode or hybrid mode. In one example, the second data exchange module 110-c-2 may generate a beacon message 125 that acknowledges receipt of the received beacon message. In addition to acknowledging receipt of the received beacon message, the generated beacon message 125 may indicate whether or not the user acknowledged receipt of the notification message. In one example, the generated beacon message 125 may indicate the presence of a device (e.g., the second device 105-a-2) and/or the presence of a user (if the user acknowledges reception, for example). As described herein, the generated beacon message 125 may include additional information.

In some embodiments, the generated beacon message 125 may be received by the first data exchange module 110-c-1 on the first device 105-a-1, which is operating in accordance with the client mode and thus listening for beacon messages. This exchange of beacon messages may result in a data exchange between the first data exchange module 110-c-1 and the second data exchange module 110-c-2. In this way, the first device 105-a-1 and the second device 105-a-2 may exchange data without network connectivity.

In some cases, the generated beacon message 125 may also be received by the third data exchange module 110-c-3 on the access point 115. In one example, upon receiving and passing along the active shooter alarm, the third data exchange module 110-c-3 may switch from operating in accordance with the access point mode to operating in accordance with a client mode or a hybrid mode so that the third data exchange module 110-c-3 may listen for and receive beacon messages.

Referring again to FIG. 7, FIG. 7 also provides an example of triggering from the second device 105-a-2 when the second device 105-a-2 is operating as a standalone device. In one example, the second device 150-a-2, as a standalone device, may have wireless capability but may not be connected to a communication network. For example, a smoke detector that includes wireless capabilities but is not connected to a communication network may be operating as a standalone device. As described previously, the second data exchange module 110-c-2 may monitor for a triggering event, and upon detecting a trigger event (which in this case may be a fire alarm based on the detection of smoke by the smoke detector), may temporarily switch from operating in accordance with a client mode to operating in accordance with an access point mode or hybrid mode, and may generate and transmit a beacon message 125 that includes information related to the detected trigger event. The first data exchange module 110-c-1 and/or the third data exchange module 110-c-3 may receive the generated beacon message.

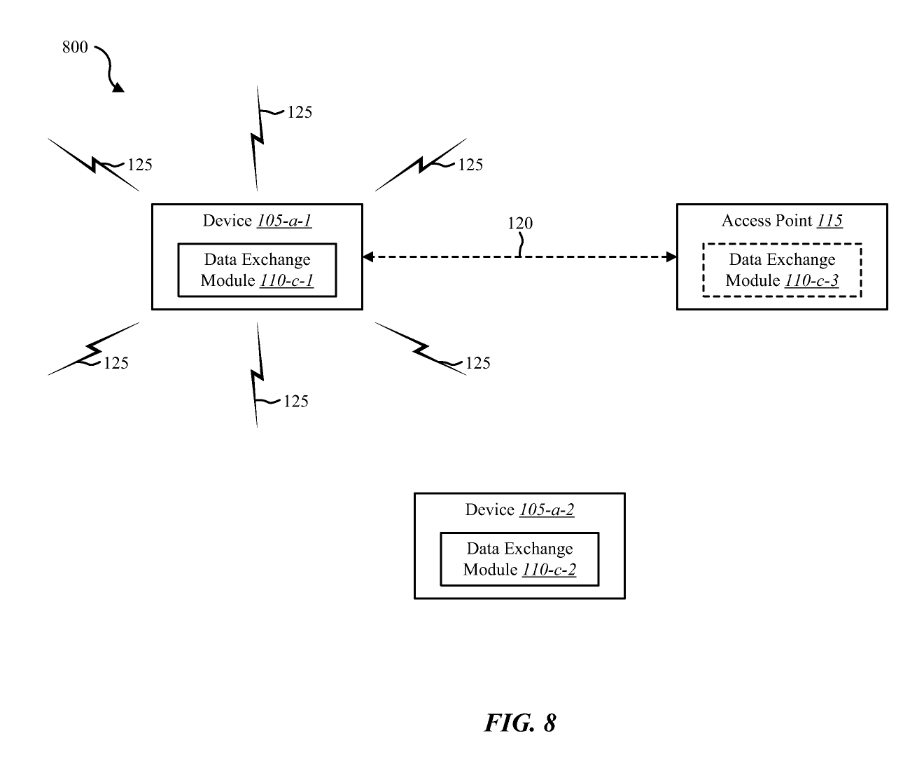

FIG. 8 is a block diagram illustrating another example of a data exchange module 110 and the environment 800 in which it may be implemented. FIG. 8 additionally illustrates one example of responsive communication from the first data exchange module 110-c-1. In one example, the first data exchange module 110-c-1, upon receiving the received beacon message may switch from operating in accordance with the client mode to operating in accordance with the access point mode or hybrid mode and may respond with its own generated beacon message 125.

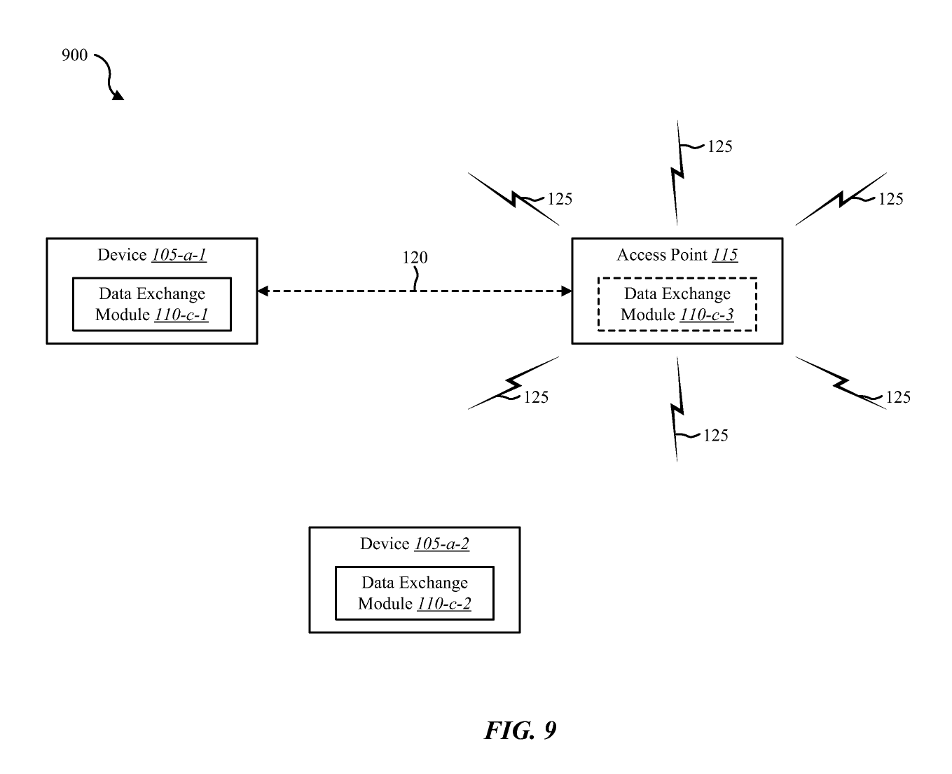

FIG. 9 is a block diagram illustrating another example of a data exchange module 110 and the environment 900 in which it may be implemented. FIG. 9 additionally illustrates one example of responsive communication from the third data exchange module 110-c-3. In one example, the third data exchange module 110-c-3, upon receiving the received beacon message (while operating in a hybrid mode, for example) may respond with its own generated beacon message 125. In some cases, this may allow for redundancy and enhance robustness of the data exchange in the case that the first device 105-a-1 becomes unavailable or goes off-line.

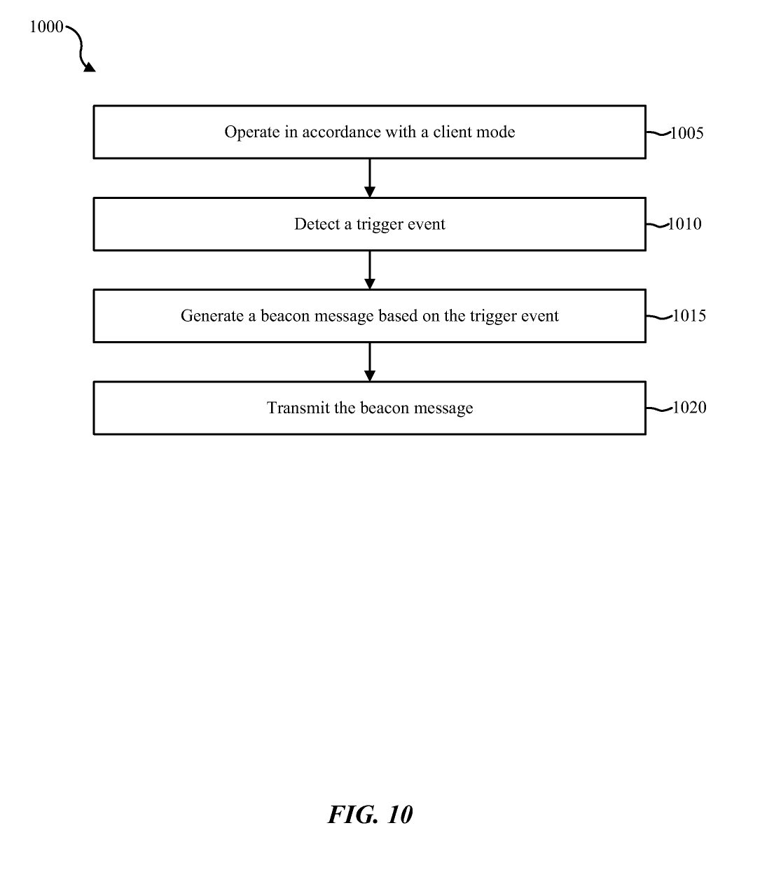

FIG. 10 is a flow diagram illustrating one embodiment of a method 1000 for communicating data. In one configuration, the method 1000 may be implemented by a device 105 such as device 105 illustrated in FIG. 1, 4, 5, 6, 7, 8, or 9. In particular, the method 1000 may be implemented by the data exchange module 110 of FIG. 1, 2, 4, 5, 7, 8, or 9.

At step 1005, the device may operate in accordance with a client mode. At step 1010, a trigger event may be detected. At step 1015, a beacon message may be generated based on the trigger event. At step 1020, the beacon message may be transmitted.

Thus, the method 1000 may provide an improved procedure for communicating data without network connectivity. It should be noted that the method 1000 is just one implementation and that the operations of the method 1000 may be rearranged or otherwise modified such that other implementations are possible.

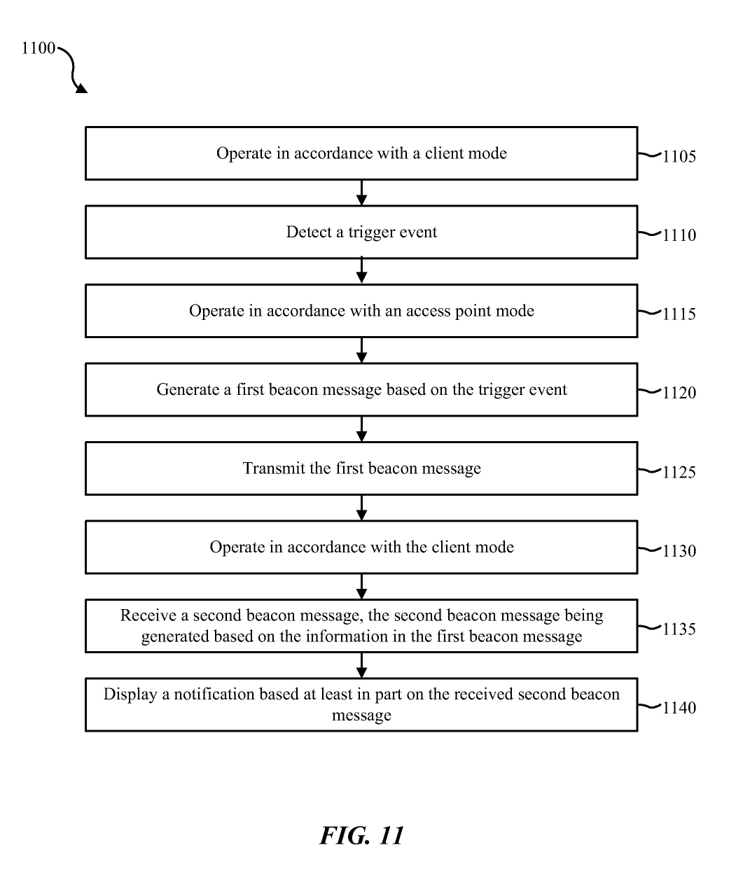

FIG. 11 is a flow diagram illustrating another embodiment of a method 1100 for communicating data. In one configuration, the method 1100 may be implemented by a device 105 such as device 105 illustrated in FIG. 1, 4, 5, 6, 7, 8, or 9. In particular, the method 1100 may be implemented by the data exchange module 110 of FIG. 1, 2, 4, 5, 7, 8, or 9.

At step 1105, the device may operate in accordance with a client mode. At step 1110, a trigger event may be detected. At step 1115, the device may operate in accordance with an access point mode. In some cases, operating in accordance with a hybrid mode includes operating in accordance with an access point mode. At step 1120, a first beacon message may be generated based on the trigger event. At step 1125, the first beacon message may be transmitted. At step 1130, the device may operate in accordance with the client mode. At step 1135, a second beacon message may be received. In one example, the second beacon message may be generated based on the information included in the first beacon message. At step 1140, a notification may be displayed. The notification may be based at least in part on the received second beacon message.

Thus, the method 1100 may provide an improved procedure for communicating data without network connectivity. It should be noted that the method 1100 is just one implementation and that the operations of the method 1100 may be rearranged or otherwise modified such that other implementations are possible.

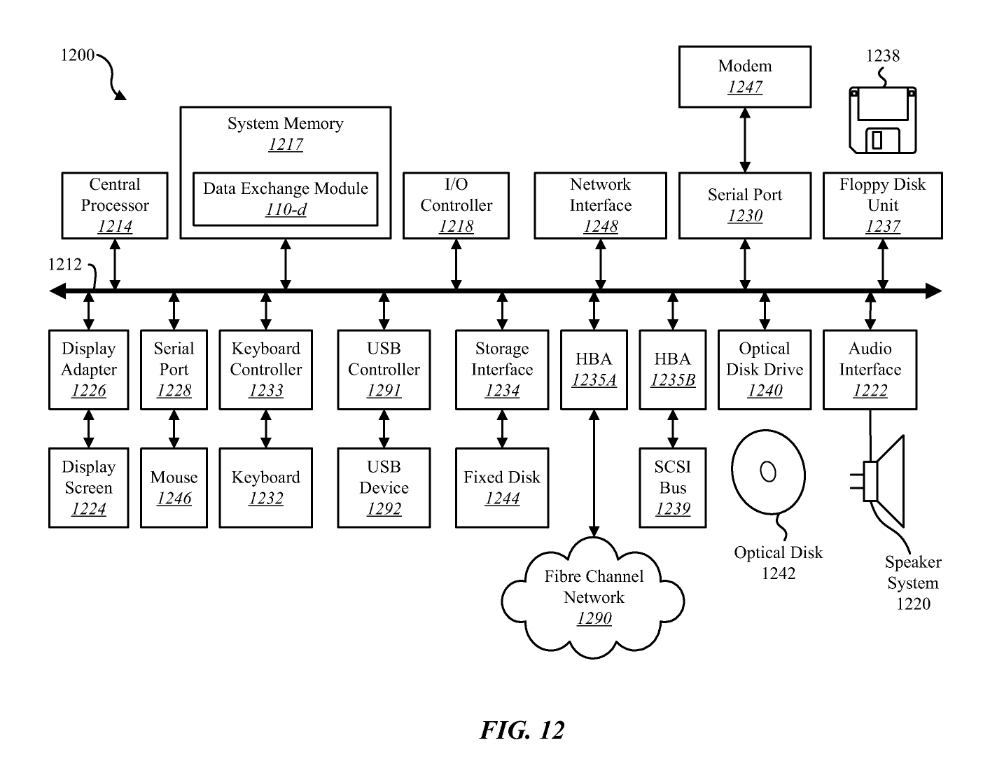

FIG. 12 depicts a block diagram of a computer system 1200 suitable for implementing the present systems and methods. Computer system 1200 includes a bus 1212 which interconnects major subsystems of computer system 1200, such as a central processor 1214, a system memory 1217 (typically RAM, but which may also include ROM, flash RAM, or the like), an input/output controller 1218, an external audio device, such as a speaker system 1220 via an audio output interface 1222, an external device, such as a display screen 1224 via display adapter 1226, serial ports 1228 and 1230, a keyboard 1232 (interfaced with a keyboard controller 1233), multiple USB devices 1292 (interfaced with a USB controller 1291), a storage interface 1234, a floppy disk unit 1237 operative to receive a floppy disk 1238, a host bus adapter (HBA) interface card 1235A operative to connect with a Fibre Channel network 1290, a host bus adapter (HBA) interface card 1235B operative to connect to a SCSI bus 1239, and an optical disk drive 1240 operative to receive an optical disk 1242. Also included are a mouse 1246 (or other point-and-click device, coupled to bus 1212 via serial port 1228), a modem 1247 (coupled to bus 1212 via serial port 1230), and a network interface 1248 (coupled directly to bus 1212).

Bus 1212 allows data communication between central processor 1214 and system memory 1217, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components or devices. For example, the data exchange module 110-d to implement the present systems and methods may be stored within the system memory 1217. Applications resident with computer system 1200 are generally stored on and accessed via a non-transitory computer readable medium, such as a hard disk drive (e.g., fixed disk 1244), an optical drive (e.g., optical drive 1240), a floppy disk unit 1237, or other storage medium. Additionally, applications can be in the form of electronic signals modulated in accordance with the application and data communication technology when accessed via network modem 1247 or interface 1248.

Storage interface 1234, as with the other storage interfaces of computer system 1200, can connect to a standard computer readable medium for storage and/or retrieval of information, such as a fixed disk drive 1244. Fixed disk drive 1244 may be a part of computer system 1200 or may be separate and accessed through other interface systems. Modem 1247 may provide a direct connection to a remote server via a telephone link or to the Internet via an internet service provider (ISP). Network interface 1248 may provide a direct connection to a remote server via a direct network link to the Internet via a POP (point of presence). Network interface 1248 may provide such connection using wireless techniques, including digital cellular telephone connection, Cellular Digital Packet Data (CDPD) connection, digital satellite data connection or the like.

Many other devices or subsystems (not shown) may be connected in a similar manner (e.g., document scanners, digital cameras, and so on). Conversely, all of the devices shown in FIG. 12 need not be present to practice the present systems and methods. The devices and subsystems can be interconnected in different ways from that shown in FIG. 12. The operation of a computer system such as that shown in FIG. 12 is readily known in the art and is not discussed in detail in this application. Code to implement the present disclosure can be stored in a non-transitory computer-readable medium such as one or more of system memory 1217, fixed disk 1244, optical disk 1242, or floppy disk 1238. The operating system provided on computer system 1200 may be MS-DOS®, MS-WINDOWS®, OS/2®, UNIX®, Linux®, or another known operating system.

Moreover, regarding the signals described herein, those skilled in the art will recognize that a signal can be directly transmitted from a first block to a second block, or a signal can be modified (e.g., amplified, attenuated, delayed, latched, buffered, inverted, filtered, or otherwise modified) between the blocks. Although the signals of the above described embodiment are characterized as transmitted from one block to the next, other embodiments of the present systems and methods may include modified signals in place of such directly transmitted signals as long as the informational and/or functional aspect of the signal is transmitted between blocks. To some extent, a signal input at a second block can be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered exemplary in nature since many other architectures can be implemented to achieve the same functionality.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

Furthermore, while various embodiments have been described and/or illustrated herein in the context of fully functional computing systems, one or more of these exemplary embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the exemplary embodiments disclosed herein.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present systems and methods and their practical applications, to thereby enable others skilled in the art to best utilize the present systems and methods and various embodiments with various modifications as may be suited to the particular use contemplated.

Unless otherwise noted, the terms “a” or “an,” as used in the specification and claims, are to be construed as meaning “at least one of.” In addition, for ease of use, the words “including” and “having,” as used in the specification and claims, are interchangeable with and have the same meaning as the word “comprising.”

What is claimed is:

1. A computer-implemented method to communicate information, comprising:
operating, by a processor of a device, in accordance with a client mode;
detecting, by the processor, a trigger event while operating in accordance with the client mode;
generating, by the processor, a beacon message in response to the detected trigger event, the beacon message including information that is based at least in part on the detected trigger event, wherein at least a portion of the information is included in a frame body of the beacon message; and
transmitting the generated beacon message.

2. (canceled)

3. The method of claim 1, further comprising:
operating in accordance with a hybrid mode, wherein operating in accordance with the hybrid mode comprises transmitting the beacon message while continuing to operate in accordance with the client mode,
wherein the transmitting the beacon message is performed while operating in accordance with the hybrid mode.

4. The method of claim 1, further comprising:
switching from operating in accordance with the client mode to operating in accordance with an access point mode, wherein operating in accordance with the access point mode comprises transmitting the beacon message, wherein at least a portion of the operating in accordance with the client mode is suspended during the operating in accordance with the access point mode,
wherein the transmitting the beacon message is performed while operating in accordance with the access point mode; and
upon transmitting the beacon message, switching from operating in accordance with the access point mode to operating in accordance with the client mode.

5. The method of claim 1, further comprising:
receiving a second beacon message from a disparate device, the second beacon message being generated by the disparate device based at least in part on the transmitted beacon message.

6. The method of claim 5, wherein the beacon message is transmitted by the device and the second beacon message is received from the disparate device without network connectivity between the device and the disparate device.

7. The method of claim 1, wherein the operating in accordance with the client mode comprises maintaining network connectivity with an access point.

8. The method of claim 1, wherein the operating in accordance with the client mode comprises listening for beacon messages.

9. The method of claim 1, wherein at least a portion of the information is included in a service set identifier (SSID) field of the generated beacon message.

10. The method of claim 1, wherein the generated beacon message is transmitted at a reduced power level.

11. The method of claim 10, further comprising:
selecting the reduced power level to reduce the area in which the transmitted beacon message is transmitted to.

12. The method of claim 1, wherein at least a portion of the information comprises control information for interacting with a disparate device.

13. A device configured to communicate information, comprising:
a processor; and
memory in electronic communication with the processor; and
instructions stored in the memory, the instructions being executable by the processor to:
operate in accordance with a client mode;
detect a trigger event while operating in accordance with the client mode;
generate a beacon message in response to the detected trigger event, the beacon message including information that is based at least in part on the detected trigger event, wherein at least a portion of the information is included in a frame body of the beacon message; and
transmit the generated beacon message.

14. (canceled)

15. The device of claim 13, wherein the instructions are executable by the processor to:
operate in accordance with a hybrid mode, wherein the instructions to operate in accordance with the hybrid mode comprise the instructions to transmit the beacon message while continuing to operate in accordance with the client mode,
wherein the instructions to transmit the beacon message are performed while operating in accordance with the hybrid mode.

16. The device of claim 13, wherein the instructions are executable by the processor to:
switch from operating in accordance with the client mode to operating in accordance with an access point mode, wherein the instructions to operate in accordance with the access point mode comprise the instructions to transmit the beacon message, wherein at least a portion of the operating in accordance with the client mode is suspended during the operating in accordance with the access point mode,
wherein the instructions to transmit the beacon message are performed while operating in accordance with the access point mode; and
upon transmitting the beacon message, switch from operating in accordance with the access point mode to operating in accordance with the client mode.

17. The device of claim 13, wherein the instructions are executable by the processor to:
receive a second beacon message from a disparate device, the second beacon message being generated by the disparate device based at least in part on the transmitted beacon message.

18. The device of claim 17, wherein the beacon message is transmitted by the device and the second beacon message is received from the disparate device without network connectivity between the device and the disparate device.

19. The device of claim 13, wherein the instructions to operate in accordance with the client mode comprises instructions executable by the processor to maintain network connectivity with an access point.

20. The device of claim 13, wherein the instructions to operate in accordance with the client mode comprises instructions executable by the processor to listen for beacon messages.

21. The device of claim 13, wherein at least a portion of the information is included in a service set identifier (SSID) field of the generated beacon message.

22. A computer-program product to communicate information, the computer-program product comprising a non-transitory computer-readable medium having instructions thereon, the instructions being executable by a processor to:
operate in accordance with a client mode;
detect a trigger event while operating in accordance with the client mode;
generate a beacon message in response to the detected trigger event, the beacon message including information that is based at least in part on the detected trigger event, wherein at least a portion of the information is included in a frame body of the beacon message; and
transmit the generated beacon message.

23. (canceled)

24. A computer-implemented method to communicate information, comprising:
operating in accordance with a client mode;
detecting a trigger event while operating in accordance with the client mode;
upon detecting the trigger event, switching from operating in accordance with the client mode to operating in accordance with an access point mode;
generating a beacon frame in response to the detected trigger event, the beacon frame including information that is based at least in part on the detected trigger event, wherein at least a portion of the information is included in a frame body of the beacon frame, and wherein the beacon frame comprises an Institute of Electrical and Electronics Engineers (IEEE) 802.11 beacon frame;
transmitting the generated beacon frame, wherein the transmitting the beacon frame is performed while operating in accordance with the access point mode; and
upon transmitting the beacon frame, switching from operating in accordance with the access point mode to operating in accordance with the client mode.
